(19) United States
(12) Patent Application Publication
(10) Pub. No.: US 2015/0285756 A1
(43) Pub. Date: Oct. 8, 2015

(54) PENCIL GRAPHITE ELECTRODE MODIFIED WITH POROUS COPPER FOR NITROPHENOL ELECTROCHEMICAL DETECTION

(71) Applicant: KING FAHD UNIVERSITY OF PETROLEUM AND MINERALS, Dhahran (SA)

(72) Inventors: Abdel-Nasser Metwally Aly Kawde, Dhahran (SA); Md. Abdul Aziz, Dhahran (SA)

(73) Assignee: KING FAHD UNIVERSITY OF PETROLEUM AND MINERALS, Dhahran (SA)

(21) Appl. No.: 14/243,762

(22) Filed: Apr. 2, 2014

(51) Int. Cl. G01N 27/30; C25D 3/38

(52) U.S. Cl. CPC G01N 27/307; C25D 3/38

(57) ABSTRACT

The pencil graphite electrode modified with porous copper may be used for the detection of 4-nitrophenol (4-NP). The pencil graphite electrode has an outer surface coated with a layer of porous copper. Prior to modification of the pencil graphite electrode, a solution of approximately 0.3 M CuSO₄ in an approximately 0.1 M acetate buffer solution (pH 4.8) is prepared. A bare pencil graphite electrode (PGE), extracted from a graphite pencil, is then immersed in this solution. An electrical potential of approximately −1.2 V is applied for approximately 60 seconds for electrodeposition of copper on the surface of the PGE to form a porous copper layer thereon. The pencil graphite electrode coated with porous copper is then removed from the mixture, washed and dried, and is then ready to be used for the electrochemical detection and quantification of 4-NP.

### BACKGROUND OF THE INVENTION

1. Field of the Invention

The present invention relates to the electrochemical quantization of analytes, and particularly to a pencil graphite electrode modified with porous copper that can be used for the detection of 4-nitrophenol (4-NP).

2. Description of the Related Art

Pencil graphite electrodes (PGEs) are common electrodes used in a variety of fields, such as electrochemistry, particularly for the electrochemical quantification of various analytes, such as trace metals, organic compounds and nucleic acids. PGEs are common due to their relatively low cost, availability, relatively small thickness, and their adjustable active surface areas, allowing them to be used to detect low analyte concentrations and analyze small sample volumes. Further, due to their low cost and wide availability, PGEs are considered to be disposable and easily replaceable.

Nitrophenols are a family of nitrated phenols with the formula HOC₆H₄NO₂. The nitrophenols are produced industrially by the reaction of chlorides with sodium hydroxide at temperatures around 200° C. The mononitrate phenols are often hydrogenated to the corresponding aminophenols that are also useful industrially. Particularly, 4-nitrophenol (also called p-nitrophenol or 4-hydroxy nitrobenzene, and commonly abbreviated as “4-NP”) is an intermediate in the synthesis of paracetamol. It is reduced to 4-aminophenol, then acetylated with acetic anhydride. 4-nitrophenol is also used as the precursor for the preparation of phenetidine and acetophenetidine, indicators, and raw materials for fungicides. Further, in peptide synthesis, carboxylate ester derivatives of 4-NP may serve as activated components for construction of amide moieties. However, despite its usefulness in industry, 4-nitrophenol is highly toxic, with exposure leading to irritation of the eyes, skin and respiratory tract. It may also cause inflammation of those parts. 4-NP has a delayed interaction with blood and forms methaemoglobin, which is responsible for methemoglobinemia, potentially causing cyanosis, confusion, and unconsciousness. When ingested, it causes abdominal pain and vomiting. Prolonged contact with skin may cause an allergic response. Genotoxicity and carcinogenicity of 4-nitrophenol are not yet known in humans. The LD₅₀ in mice is 282 mg/kg and in rats is 202 mg/kg (p.o.). Given its wide-ranging use in the industry and its toxicity, detection of 4-NP in samples, such as blood, urine and saliva, is of great importance.

Several methods have been developed for the measurement of 4-NP, including UV-visible spectrophotometry, spectrofluorimetry, high performance liquid chromatography, flow injection analysis, and enzyme linked immunosorbent assays. However, these techniques typically require pretreatment involving separation, extraction and adsorption, which is both costly and time consuming. As a result, these methods are not suitable for monitoring 4-NP in the field.

Analyte detectors and sensors based on nanomaterials, particularly using copper, are of great interest. It is desirable to combine the electrochemical benefits of a copper-based sensor with the effectiveness and ease of manufacture and use of the pencil graphite electrode, particularly for the detection of 4-NP.

Thus, a pencil graphite electrode modified with porous copper addressing the aforementioned problems is desired.

### SUMMARY OF THE INVENTION

The pencil graphite electrode modified with porous copper can be used for the detection of 4-nitrophenol (4-NP). The pencil graphite electrode has an outer surface coated with a layer of porous copper. Prior to modification of the pencil graphite electrode, a solution of approximately 0.3 M CuSO₄ in an approximately 0.1 M acetate buffer solution (pH 4.8) is prepared. A bare pencil graphite electrode (PGE), extracted from a graphite pencil, is then immersed in this solution. An electrical potential of approximately −1.2 V is applied for approximately 60 seconds for electrodeposition of copper on the surface of the PGE to form a porous copper layer thereon. The pencil graphite electrode coated with porous copper is then removed from the mixture, washed and dried, and is then ready to be used for the electrochemical detection and quantification of 4-NP.

These and other features of the present invention will become readily apparent upon further review of the following specification.

### BRIEF DESCRIPTION OF THE DRAWINGS

FIG. 1A is a graph comparing cyclic voltammograms of an unmodified pencil graphite electrode, used as a control, in a 0.1 M acetate buffer solution (pH 4.8) (a) in the absence of 4-nitrophenol (4-NP) against (b) a solution of 1 mM 4-NP in the acetate buffer, specifically examining the oxidation of 4-NP by the unmodified pencil graphite electrode.

FIG. 1B is a graph comparing cyclic voltammograms of an unmodified pencil graphite electrode, used as a control, in a 0.1 M acetate buffer solution (pH 4.8) (a) in the absence of 4-nitrophenol (4-NP) against (b) a solution of 1 mM 4-NP in the acetate buffer, specifically examining the reduction of 4-NP by the unmodified pencil graphite electrode.

FIG. 1C is a graph comparing cyclic voltammograms of a pencil graphite electrode modified with porous copper according to the present invention, in a 0.1 M acetate buffer solution (pH 4.8) (a) in the absence of 4-nitrophenol (4-NP) against (b) a solution of 1 mM 4-NP in the acetate buffer, specifically examining the reduction of 4-NP by the pencil graphite electrode modified with porous copper.

FIG. 2A is a cyclic voltammogram comparing 4-NP reduction using pencil graphite electrode modified with porous copper according to the present invention, prepared with varying concentrations of CuSO₄.

FIG. 2B is a cyclic voltammogram comparing 4-NP reduction using pencil graphite electrode modified with porous copper according to the present invention, prepared with varying copper electrodeposition times.

FIG. 3A shows an amperogram of an unmodified pencil graphite electrode, used as a control, in 10 mL of an acetate buffer (0.1 M, pH 4.8) at potential of −0.50 V during successive addition of 50 μM 4-NP.

FIG. 3B shows an amperogram of the pencil graphite electrode modified with porous copper according to the present invention in 10 mL of an acetate buffer (0.1 M, pH 4.8) at potential of −0.50 V during successive addition of 50 μM 4-NP.

FIG. 4 is a comparison of amperometric responses for the pencil graphite electrode modified with porous copper according to the present invention, comparing values for successive additions of 4-NP; 4-aminophenol (AP); phenol (P); 3,4-dichlorophenol (CP); and also 4-NP at potential of −0.5 V.

Unless otherwise indicated, similar reference characters denote corresponding features consistently throughout the attached drawings.

### DETAILED DESCRIPTION OF THE PREFERRED EMBODIMENTS

The pencil graphite electrode modified with porous copper can be used for the detection of 4-nitrophenol (4-NP). The pencil graphite electrode has an outer surface coated with a layer of porous copper. Prior to modification of the pencil graphite electrode, a solution of 0.3 M CuSO₄ in a 0.1 M acetate buffer solution (pH 4.8) was prepared. A 10 mm bare pencil graphite electrode (PGE), extracted from a graphite pencil, was immersed in this solution. An electrical potential of approximately −1.2 V was applied for approximately 60 seconds for electrodeposition of copper on the surface of the PGE to form a porous copper layer thereon. As will be described in detail below, various concentrations of CuSO₄ and various electrodeposition potentials and times were experimented with, and 0.3 M CuSO₄, with a potential of −1.2 V and a deposition time of 60 seconds were found to be most effective. The pencil graphite electrode coated with porous copper was then removed from the mixture, washed and dried, and was then ready to be used for the electrochemical detection and quantification of 4-NP.

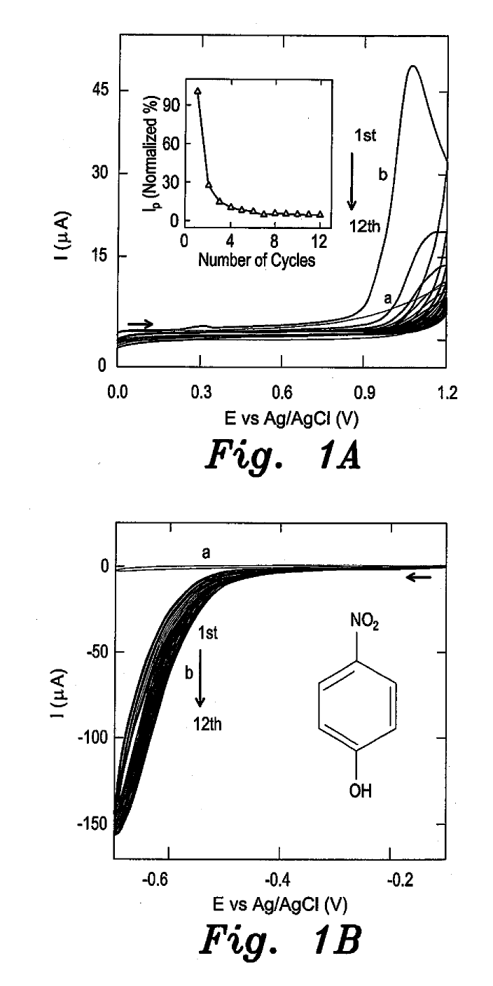

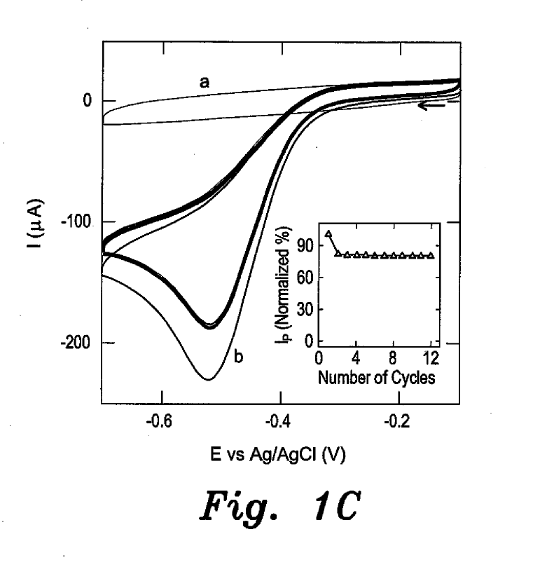

As illustrated in the inset of FIG. 1B, 4-NP has a nitro (—NO₂) group at the opposite position of a hydroxyl (—OH) group on a benzene ring. As a result of this, it is possible to detect 4-NP by measuring the oxidation of the OH group or reduction of the NO₂ group. FIG. 1A shows the cyclic voltammograms (CVs) in the absence (a) and presence (b) of 1 mM 4-NP in acetate buffer (0.1 M, pH 4.8) for an uncoated, or “bare” PGE, used as a control. By comparing the CVs of FIG. 1A, it is clear that bare PGE can oxidize 4-NP at +1.07 V, which is high enough to oxidize some interferents. The oxidation signal of the phenolic group decreases significantly from the first to the second cycle and then slowly decreases the signal while increasing the number of the cycle. As shown in the inset of FIG. 1A, no oxidation signal appears in this CV experiment for the bare PGE. The signal decrease might be due to the deposition of the oxidative products (dimer or polymer) on the electrode surfaces, which hinder further oxidation of 4-NP. The signal decreasing behavior is similar to phenol oxidation on other types of electrodes.

The results of examining the reduction of 4-NP for the bare PGE are shown in FIG. 1B, and the results of examining the reduction of 4-NP with the present pencil graphite electrode modified with porous copper are shown in FIG. 1C. FIG. 1B shows the cyclic voltammograms (CVs) of bare PGE in the absence (a) and presence (b) of 1.0 mM 4-NP in acetate buffer (0.1 M, pH 4.8). The CV data shown in FIG. 1B for curves “a” and “b” confirm that the bare PGE can reduce 4-NP at a high negative potential without any peaks in the entire test potential window. This reduction potential should be shifted positively to fabricate an ideal 4-NP sensor. In contrast to oxidation current, the reduction current of 4-NP did not change significantly by increasing the number of cycles in the CV experiments.

To reduce the 4-NP at low potential with a stable electrochemical signal, the PGE is modified with copper from solution of 0.1 M CuSO₄ in 0.1 M acetate buffer (0.1 M, pH 4.8) by electrodeposition at −1.0 V for 60 seconds, as described above. The CVs were recorded in acetate buffer (0.1 M, pH 4.8) in the absence (curve “a” in FIG. 1C) and presence (curve “b” in FIG. 1C) of 1 mM 4-NP. The CVs of curves “a” and “b” of FIG. 1C confirm that the pencil graphite electrode modified with porous copper can reduce the 4-NP at low potential with a peak potential at −0.52 V. Additionally, the electro reduction current of 4-NP for the pencil graphite electrode modified with porous copper (curve “b” in FIG. 1C) is significantly higher than that of the bare PGE (curve “b” in FIG. 1B). The reduction of 4-NP for the pencil graphite electrode modified with porous copper may be attributed to the excellent electrocatalytic properties of copper.

Further, the pencil graphite electrode modified with porous copper showed significantly decreased overvoltage for the reduction of 4-NP compared to that of the bare PGE. Thus, the electrodeposited copper is suitable as a mediator to shuttle electrons between 4-NP and the PGE, and further facilitates electrochemical generation following electron exchange with 4-NP. The inset of FIG. 1C is the plot of normalized reduction peak height of 1 mM 4-NP for the pencil graphite electrode modified with porous copper vs. number of cycles in the CV experiment. This plot confirms the reduction current is decreased a little from the first cycle to the second cycle and remains constant from the second cycle to the twelfth cycle; i.e., the pencil graphite electrode modified with porous copper is quite stable in the reduction of 4-NP.

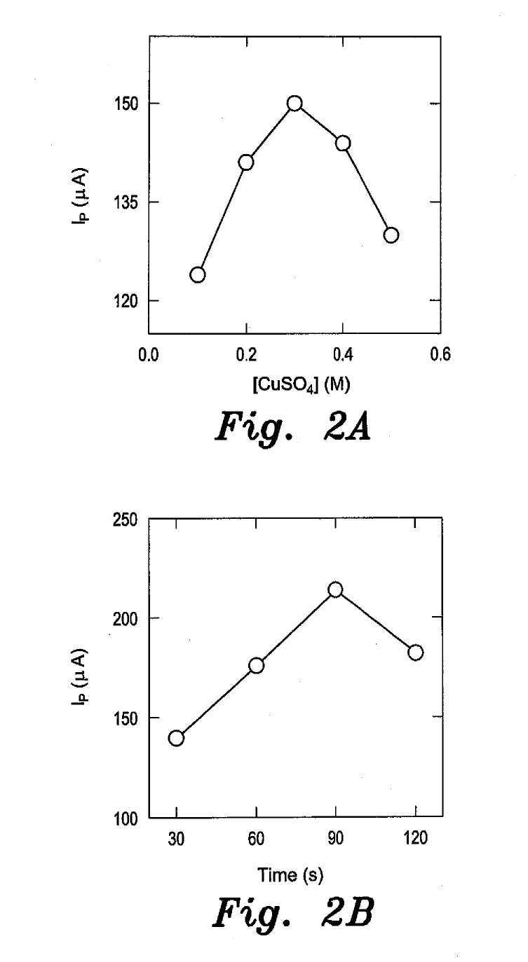

In order to optimize the pencil graphite electrode modified with porous copper, experiments were performed in which the pencil graphite electrode was prepared using varying concentrations of CuSO₄, specifically between 0.1 M and 0.5 M at a constant applied potential (−1.0 V) and time (60 seconds). The CVs of the modified electrode in acetate buffer (0.1 M, pH 4.8) containing 1 mM 4-NP are shown in FIG. 2A and illustrate the reduction peak height increase with an increase in the concentration of CuSO₄ up to 0.3 M. Further increasing of the concentration of CuSO₄ decreases the reduction peak height of 4-NP; i.e., 0.3 M was found to be the optimum concentration of CuSO₄ in the preparation of the pencil graphite electrode modified with porous copper.

The electrodeposition potential was next varied between −0.8 V and −2.0 V for a constant concentration of CuSO₄ (0.3 M) and electrodeposition time (60 seconds). The plot of reduction peak height vs. electrodeposition potential of copper showed the peak height of the 4-NP reduction increased with increases in the electrodeposition potential during the preparation of the pencil graphite electrode modified with porous copper. However, the deposited copper on the PGE was not stable for potentials less than −1.2 V. Thus, −1.2 V was selected as the optimal electrodeposition potential. The copper deposition time was also varied between 30 and 120 seconds at constant electrodeposition potential (−1.2 V) and concentration of CuSO₄ [0.3 M]. FIG. 2B illustrates the reduction peak height of 4-NP vs. electrodeposition time, showing that the reduction peak height is increased by increasing the electrodeposition time up to 90 seconds. Further increasing the deposition time decreases the peak height of 4-NP reduction. However, 60 seconds was selected as the optimum electrodeposition time, since the deposited copper is not stable when prepared at extended times on the order of 90 seconds. Thus, the optimal conditions for preparation of the modified PGE were found to be 0.3 M CuSO4, −1.2 V and 60 seconds, respectively.

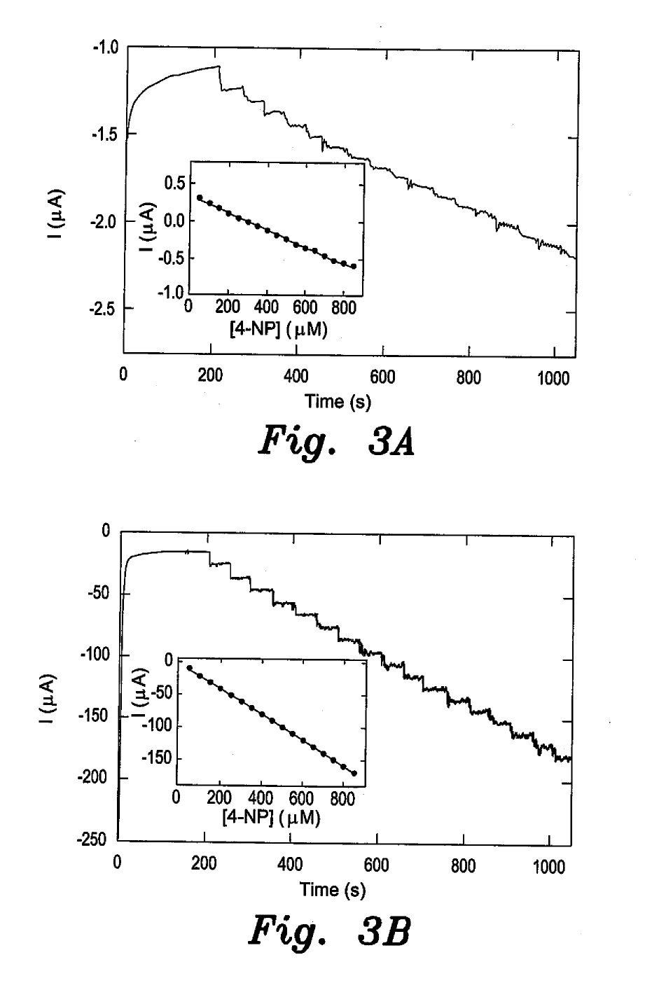

Field emission scanning electron microscopy (FE-SEM) on the present pencil graphite electrode modified with porous copper, such as a pencil graphite electrode having an outer surface coated with a layer of porous copper, revealed that the copper was optimally deposited as random sub-microparticles with a high degree of porosity. The 4-NP concentration-dependent signal and detection limits for the bare PGE and the pencil graphite electrode modified with porous copper were further measured using the amperometric method. FIG. 3A shows typical amperometric responses of the bare PGE and FIG. 3B shows the amperometric responses of the pencil graphite electrode modified with porous copper at −0.5 V upon successive additions of 50 μM 4-NP. The pencil graphite electrode modified with porous copper, as shown in FIG. 3B, yielded a well-defined and sensitive signal for each addition of 4-NP, whereas the bare PGE gave a poor signal. The concentration-dependent signal (shown in the insets in FIGS. 3A and 3B) was linear over the entire 4-NP concentration range tested for the pencil graphite electrode modified with porous copper (R² =0.9997) and for the bare PGE (R² =0.9985), after subtracting the mean of the corresponding zero 4-NP response. Both electrodes followed a linear trend that could be fit to a linear equation, such as of the form y=mx+b. The detection limits of 4-NP at an applied potential of −0.5 V for the pencil graphite electrode modified with porous copper and the bare PGE were 1.9 μM and 1.0 mM, respectively.

Additionally, the pencil graphite electrode modified with porous copper sensor for 4-NP was tested against prior sensors, including graphene-gold composite on PGE; inorganic-organic coatings on platinum; graphene-solid-phase-extraction (graphene-SPE); and a PGE modified with gold nanoparticles (AuNP-PGE). The comparison for a variety of detection methods, analytical ranges, square of the correlation coefficient, and detection limits are shown below in Table 1, and indicate that the present pencil graphite electrode modified with porous copper has a performance comparable to the other 4-NP sensors in Table 1.

TABLE 1
Comparison of Pencil Graphite Electrode Modified
With Porous Copper Sensor With Other Modified
Electrode-Based Sensors for 4-NP Detection

| | | | Analyt- | | Detec- |
|---|---|---|---|---|---|
| | | | ical | | tion |
| | Sensing | Sensing | ranges | | limit |
| Methods | materials | media | (μM) | R² | (μM) |
| Amperometry | Pencil Graphite | 0.1M | 50- | 0.9997 | 1.91 |
| | Electrode | acetate | 850 | | |
| | Modified With | buffer | | | |
| | Porous Copper | (pH 4.8) | | | |
| Amperometry | Graphene-Gold | 0.1M | 0.47- | 0.9943 | 0.47 |
| | Composite on | H₂SO₄ | 10750 | | |
| | PGE | | | | |
| Square wave | Inorganic- | 0.1M | 30- | 0.9954 | 8.23 |
| voltammetry | Organic | PB | 90 | | |
| | Coatings on Pt | (pH 6.0) | | | |
| | Electrode | | | | |
| Differential | Graphene-SPE | 0.02M | 10- | 0.9837 | 0.60 |
| pulse | | H₂SO₄ | 620 | | |
| voltammetry | | | | | |
| Semi- | AuNP-PGE | 0.1M | 10- | — | 8.00 |
| derivative | | PB | 1000 | | |
| volt- | | (pH 6.0) | | | |
| ammograms | | | | | |

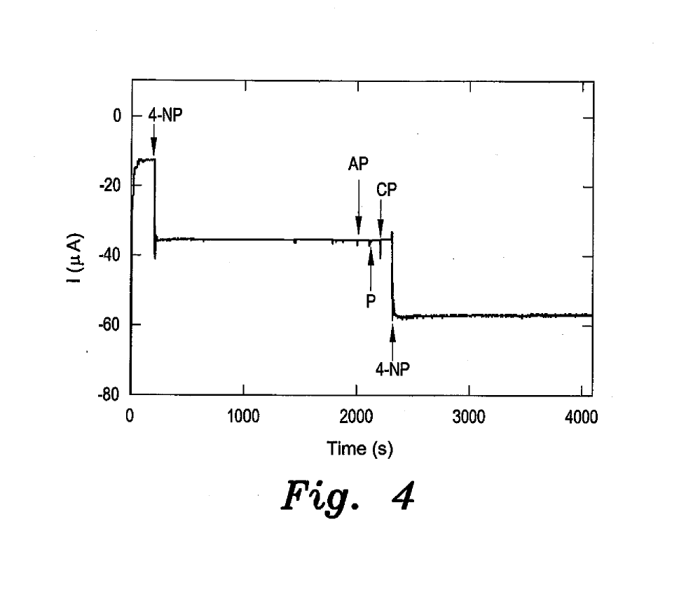

FIG. 4 shows the amperometric response to successive additions of 4-NP, 4-aminophenol (AP), phenol (P), 3,4-dichlorophenol (CP) and also 4-NP at −0.5 V for a given surface of the pencil graphite electrode modified with porous copper. A well-defined 4-NP response is observed upon addition of 100 μM 4-NP. The response remained stable during a prolonged 30.0 minute experiment. Following this, subsequent injections of 50 μM of 4-aminophenol, 50 μM of phenol and 50 μM of 3,4-dichlorophenol did not produce additional signals or even modify the obtained current response. Further additions of 100 μM 4-NP produce well-defined and reproducible sensor response, which was stable again during a prolonged 30.0 minute experiment, demonstrating 4-NP sensing selectivity and sensitivity at the pencil graphite electrode modified with porous copper.

It is to be understood that the present invention is not limited to the embodiments described above, but encompasses any and all embodiments within the scope of the following claims.

We claim:

1. A pencil graphite electrode modified with porous copper, comprising a pencil graphite electrode having an outer surface coated with a layer of porous copper.

2. The pencil graphite electrode modified with porous copper as recited in claim 1, wherein the porous copper is formed on the outer surface of the pencil graphite electrode as random sub-microparticles.

3. A method of making a pencil graphite electrode modified with porous copper, comprising the steps of:
mixing CuSO₄ in an acetate buffer solution to make an electrodeposition solution;
immersing a pencil graphite electrode in the electrodeposition solution; and
applying an electrical potential across the pencil graphite electrode to form a pencil graphite electrode modified with porous copper through electrodeposition of copper on a surface of the pencil graphite electrode.

4. The method of making a pencil graphite electrode modified with porous copper as recited in claim 3, wherein the step of mixing the CuSO₄ in the acetate buffer solution comprises mixing the CuSO₄ into an acetate buffer solution having a concentration of approximately 0.1 M.

5. The method of making a pencil graphite electrode modified with porous copper as recited in claim 4, wherein the step of mixing the CuSO₄ in the acetate buffer solution comprises mixing the CuSO₄ into an acetate buffer solution having a pH of approximately 4.8.

6. The method of making a pencil graphite electrode modified with porous copper as recited in claim 5, wherein the step of mixing the CuSO₄ in the acetate buffer solution comprises mixing the CuSO₄ into the acetate buffer solution such that the CuSO₄ has a concentration of approximately 0.3 M in the electrodeposition solution.

7. The method of making a pencil graphite electrode modified with porous copper as recited in claim 6, wherein the step of applying the electrical potential across the pencil graphite electrode comprises applying an electrical potential of approximately −1.2 V across the pencil graphite electrode.

8. The method of making a pencil graphite electrode modified with porous copper as recited in claim 7, wherein the step of applying the electrical potential across the pencil graphite electrode comprises applying the electrical potential across the pencil graphite electrode for a period of approximately 60 seconds.
